(19) United States
(12) Patent Application Publication
(10) Pub. No.: US 2011/0161211 A1
(43) Pub. Date: Jun. 30, 2011

(54) Real-Time Settling of Payment for Logistics Company

(75) Inventors: Zhenghua Zhang, Hangzhou (CN); Xiang Ding, Hangzhou (CN)

(73) Assignee: Alibaba Group Holding Limited, Grand Cayman (KY)

(21) Appl. No.: 12/739,103

(22) PCT Filed: Sep. 15, 2009
(86) PCT No.: PCT/US09/57011

§ 371 Date: Apr. 21, 2010

(30) Foreign Application Priority Data
Sep. 16, 2008 (CN) 200810212055.3

(51) Int. Cl. G06Q 20/00; G06Q 40/00

(52) U.S. Cl. 705/30; 705/44

(57) ABSTRACT

A method and a system provide real-time payment fund settlement of a logistics company using a third-party payment platform, which signs a withholding agreement with the logistics company and a logistics agency and establishes separate payment accounts for the logistics company and the logistics agency. The logistics company sends a withholding instruction to the third-party payment platform upon receiving signature information and goods information sent by the courier after the buyer has made a payment and signed for the acceptance of the goods. After receiving the withholding instruction, the third-party payment platform verifies the withholding instruction based on the withholding agreement, and transfers a fund from the payment account of the logistics agency to the payment account of the logistics company. The disclosed method and system can greatly increase the speed of fund transfer and fund settlement between the logistics company and the logistics agency.

### RELATED APPLICATIONS

This application is a national stage application of international patent application PCT/US09/57011, filed Sep. 15, 2009, entitled “REAL-TIME SETTLING OF PAYMENT FOR LOGISTICS COMPANY”, which claims priority from Chinese patent application, Application No. 200810212055.3, filed Sep. 16, 2008, entitled “METHOD AND SYSTEM FOR REAL-TIME SETTLING OF PAYMENT FOR LOGISTICS COMPANY”.

### TECHNICAL FIELD

The present disclosure relates to methods and systems of settling a payment for a logistics company, and particularly relates to methods and systems of settling a payment for a logistics company in real time.

### BACKGROUND

Logistics transportation occupies an important position in modern economic life frequent business activities. Logistics refers to an entire process of transferring goods from a factory warehouse to a consignee. Efficiency and quality of the logistic transportation service have a direct impact on productions and operations of companies of various kinds.

As the market reform becomes deeper, logistics in this country is no longer a simple combination of transporting, warehousing, loading and unloading, handling, packaging, processing and dispatching, but rather begins to provide cost-oriented services for consumers, gradually developing in directions of becoming multi-functional, scalable and networked.

For example, Chinese patent application number 300420052481.2 discloses a wirelessly communicated logistics networking structure. As shown in FIG. 1, the disclosed structure includes three parts built upon the Internet. A wireless vehicle network is formed primarily of a car-mounted terminal and a public wireless communication network. A car-mounted terminal is installed with a GPS receiving module and a wireless communication module. A local area network of the control management center is an intranet established with a central database as the core, and may connect with existing network(s) of company management system(s), the network of separate control centers, and 110 alarm network(s). The network of separate control centers refers to ordinary computers and portable computers which are used by authorized users and which have monitoring software installed, connecting to the central database through the Internet or a wireless network. Using the GPS receiving module and the wireless communication module installed in the car-mounted terminal, the logistics networking structure uses wireless communication to monitor the car-mounted terminal and allows a courier to communicate with a logistics company at any time during delivery. The structure may have characteristics of requiring less investment, easy implementation, quick popularization and powerful functionalities.

In another example, “Palmtop Logistics” introduced by China Unicom equips a courier with a CDMA mobile phone and allows the courier to complete various aspects of work such as data collection and data communication on the move. This design makes full use of automatic recognition technology, mobile communication technology, GPSone positioning technology and network database technology, provides to a logistics company important functions such as voice, data communication, positioning, photographing and scanning, and helps the logistics company achieve highly efficient and smooth three-node operations of collection, transportation and delivery.

During the collection stage, the courier can remotely log into the company's system through the CDMA mobile phone to download new delivery tasks using the mobile phone at any time and place, and to accurately feedback a status of logistics task at any time and any place. Upon receiving goods, the courier can take a picture of a bar code using the mobile phone to automatically collect an invoice number. This allows a scan of the invoice number and quick report of information such as names of the goods, a consignee and a destination city. The security characteristic of the CDMA mobile phone ensures security and reliability of the goods information, thus achieving timely exchange of the goods information.

During the transportation stage, the GPS positioning function of CDMA allows a management person to timely control the route of a person and a vehicle at a distant location, with position accuracy of up to five to fifty meters. Not only can the route be tracked continuously, a replay of the route is also possible using “Palmtop Logistics”, allowing the management person to input a time segment for route replaying to find out the historical course of the vehicle and the person.

During the delivery stage, signature information and the goods information can be barcode-scanned, photographed and timely transmitted using the CDMA mobile phone through a CDMA network to accomplish shipment delivery and electronic signing for acceptance of the goods. In the process, recording a waybill and a receipt is achieved using a mobile phone with the current status of the waybill being tracked using a tracking number to support a comprehensive inquiry of information such as waybills, remaining waybills and lost waybills.

The above two logistics technologies both use a wireless communication network for real-time information exchange between a logistics company and a truck/courier. However, merely using these logistics technologies does not guarantee a competitive edge of a logistics company if the network, functions, service and performance are evaluated comprehensively.

For example, if a logistics company needs to manage logistics providers in multiple regions at the same time, its management cost will increase enormously. As a result, many logistics companies recruit logistics agencies in various regions in order to reduce operating costs. Goods delivery in different regions will then be handled by the logistics agencies in corresponding regions. One problem faced by this collaboration model is the fund settlement between the logistics company and the various logistics agencies. Since each logistics agency has its own bank account, a payment needs to be transferred from the bank account of the logistics agency to a bank account of the logistics company once the payment is received upon delivery.

In typical transfer of a payment fund, a courier delivers goods to a buyer and receives a payment. The courier then sends signature information indicating the acceptance of the goods by the buyer to a logistics agency and notifies the logistics agency that the payment has been received. The logistics agency subsequently transfers the payment from its bank account into a bank account of a logistics company. Upon receiving the payment from the logistics agency, the logistics company passes the payment to a seller.

During this process of payment transfer, the logistics agency cannot settle a payment with the logistics company immediately after the courier notifies the logistics agency of receipt of the payment. Rather, the payment is held by a bank for a certain period of time (e.g., a day) before it can be transferred to the logistics company. Efficiency of the entire fund transfer is thus relatively low, resulting in a longer time taken for the payment to reach the seller and reduced efficiency of transaction. Furthermore, as logistics companies generally require a logistics agency to pay a certain amount of security deposit during delivery, slow payment transfer will increase financial pressure on the logistics agency to cause operating difficulties.

### SUMMARY OF THE DISCLOSURE

Disclosed are a method and a system that provide real-time payment fund settlement of a logistics company using a third-party payment platform, which signs a withholding agreement with the logistics company and a logistics agency and establishes separate payment accounts for the logistics company and the logistics agency. The logistics company sends a withholding instruction to the third-party payment platform upon receiving signature information and goods information sent by the courier after the buyer has made a payment and signed for the acceptance of the goods. After receiving the withholding instruction, the third-party payment platform verifies the withholding instruction based on the withholding agreement, and transfers a fund from the payment account of the logistics agency to the payment account of the logistics company. The disclosed method and system can greatly increase the speed of fund transfer and fund settlement between the logistics company and the logistics agency.

In one embodiment, transferring the fund from the account of the logistics agency to the account of the logistics company at the third-party payment platform to settle the payment is conducted immediately upon receiving and verifying the withholding command to achieve real-time fund settlement between the logistics company and the logistics agency upon a successful delivery of the goods.

After the logistics company, the logistics agency and the third-party payment had signed the withholding agreement, the third-party payment platform may keep a record of the contents of the withholding agreement for use in access control of subsequent withholding requests. The third-party payment platform may verify the identities of the logistics company and the logistics agency when signing the withholding agreement. One exemplary way to verify the identities of the logistics company and the logistics agency is by verifying passwords and digital certificates.

In one embodiment, the withholding instruction is encrypted and transmitted using a secure socket layer protocol when the logistics company sends the withholding instruction to the third-party payment platform.

Upon receiving and successfully verifying the withholding instruction from the logistics company, the third-party payment platform may store the accounting details contained in the withholding instruction for use in account reconciliation.

A system of settling a payment between a logistics company and a logistics agency has one or more server computers programmed or adapted for acting as a third-party payment platform which signs a withholding agreement with the logistics company and the logistics agency. The third-party payment platform is further adapted for performing the following acts: (1) establishing an account for the logistics company and an account for the logistics agency at the third-party payment platform; (2) receiving a withholding command from the logistics company which sends the withholding command upon receiving delivery information from a courier of the logistics agency indicating that a buyer has made a payment and signed for receipt of the goods; and (3) verifying the withholding command based on the withholding agreement; and (4) transferring a fund from the account of the logistics agency to the account of the logistics company at the third-party payment platform to settle the payment.

In one embodiment, the third-party payment platform has several modules. A payment account management module is adapted for establishing the account for the logistics company and the account for the logistics agency. A withholding agreement registration module connecting with the logistics company and the logistics agency is adapted for signing the withholding agreement among the logistics company, the logistics agency and the third-party payment platform. A withholding access control module connecting with the withholding agreement registration module is adapted for keeping a record of the withholding agreement for use in access control of subsequent withholding requests. A withholding module separately connecting with the withholding access control module and the payment account management module is adapted for transferring the fund from the account of the logistics agency to the account of the logistics company upon receiving the withholding command One or more of the above modules may be a separate server computer.

Compared with existing technologies, the disclosed method and the system may have the advantages. The disclosed method and the system achieve real-time fund settlement between a logistics agency and a logistics company using a third-party payment platform, and greatly increase the speed of fund transfer and fund settlement between the logistics agency and the logistics company. The method and the system also shorten the time duration of making a security deposit by the logistics agency to the logistics company, thus decreasing financial pressure on the logistics agency as well as operating difficulties of the logistics agency. The security of the payment transfer between the logistics company and a logistics agency is insured by the third-party payment platform using various security means such as encryption.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 shows a schematic diagram illustrating a wirelessly communicated logistics networking structure described in Chinese patent application number 300420052481.2.

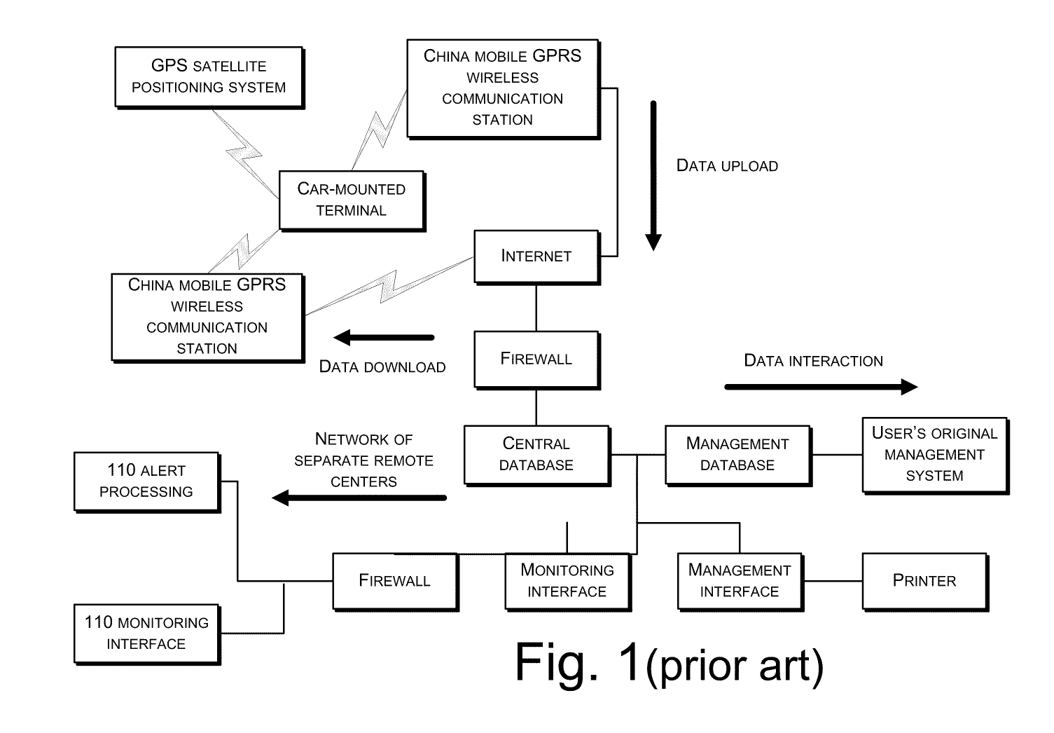

FIG. 2 shows a flow chart illustrating an exemplary method of real-time payment fund settlement of a logistics company in accordance with the present disclosure.

FIG. 3 shows a flow chart illustrating another exemplary method of real-time payment fund settlement of a logistics company in accordance with the present disclosure.

FIG. 4 shows a structural diagram illustrating an exemplary system of real-time payment fund settlement of a logistics company in accordance with the present disclosure.

FIG. 5 shows a structural diagram illustrating an exemplary third-party payment platform in accordance with the present disclosure.

FIG. 6 shows a structural diagram illustrating another exemplary third-party payment platform in accordance with the present disclosure.

### DETAILED DESCRIPTION

The idea of the present disclosure is to use a third-party payment platform to settle a fund between a logistics company and a logistics agency in real time in order to improve the speed of fund transfer and fund settlement between the logistics company and the logistics agency. The third-party payment platform described in the present disclosure refers to a transaction payment platform provided by a third-party independent organization that has signed agreements with various domestic and overseas banks and has certain credibility and reputation. An example of such third-party payment platform is AliPay. The third-party payment platform may provide the following primary functions:

1. A user may use means such as online banking to recharge the user's account on the third-party payment platform using funds in a bank account.

2. Upon selecting a product, a buyer may use an account provided by the third-party payment platform to make a payment and transfer the payment to a seller's account on the third-party payment platform.

3. A user may deposit funds from an account on the third-party payment platform into user's bank account.

The present disclosure is described in details using accompanying figures. First provided is a method of settling a fund between the logistics company and a logistics agency in real time after a buyer has made the payment and signed for the goods.

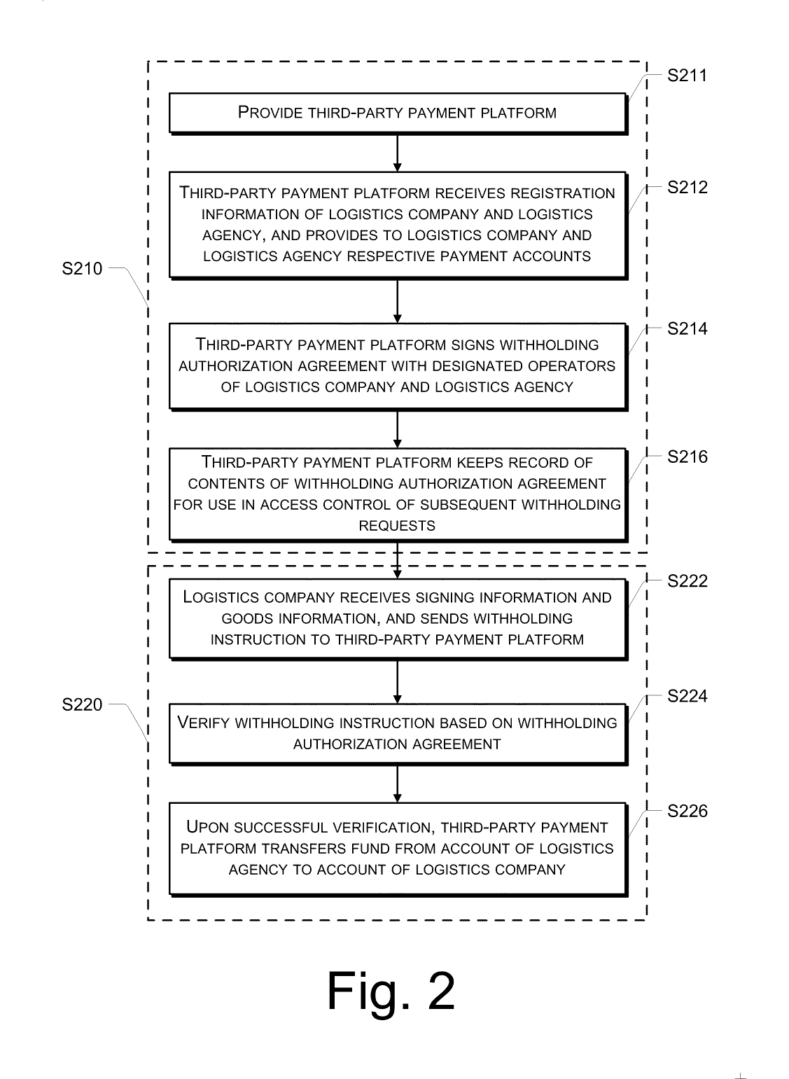

FIG. 2 shows a flow chart illustrating an exemplary method of settling a payment for a logistics company in real time. In this description, the order in which a process is described is not intended to be construed as a limitation, and any number of the described process blocks may be combined in any order to implement the method, or an alternate method.

Overall, the method includes a process of signing withholding agreement 5210 and a process of real-time payment settlement 5220. Signing a withholding agreement refers to a process of signing the withholding agreement by a logistics company, a logistics agency and a third-party payment platform. The process of signing withholding agreement 5210 is described first below.

At S211, a third-party payment platform is provided.

At S212, the third-party payment platform receives registration information of a logistics company and a logistics agency, and provides respective payment accounts to the logistics company and the logistics agency. During registration, the logistics company and the logistics agency may designate respective operators to log onto the third-party payment platform and input the registration information. The registration information may be a login account, a login password, a company name, etc. Upon successful registration, the third-party payment platform provides to the logistics company and the logistics agency their respective payment accounts.

At S214, the operators designated by the logistics company and the logistics agency sign a withholding agreement. To authorize the withholding agreement, the operators of the logistics company and the logistics agency log onto a webpage of withholding agreement of the third-party payment platform and sign the agreement according to instructions in the content. When signing the withholding agreement, the operators are required to agree to authorize the third-party payment platform to deduct funds from the accounts on the third-party payment platform according to a system command from the logistics company.

At S216, the third-party payment platform keeps a record of the contents of the withholding agreement for use in access control of subsequent withholding request. The contents of the withholding agreement includes details of the authorization agreement and information of the three parties that sign the agreement such as withholding process, withholding instructions, matters that the three parties must not violate, the registration information of the logistics company and the logistics agency which have signed the agreement, etc.

The process of real-time payment settlement S220 refers to a process of settling a fund transfer from the logistics agency's account to the logistics company's account in real time after a courier has received a payment from a buyer. The process includes the following procedures.

At S222, the third-party payment platform receives a withholding command from the logistics company which sends the withholding command upon receiving delivery information from a courier of the logistics agency indicating that a buyer has made a payment and signed for receipt of the goods. In practice, the logistics company receives signature information indicating acceptance of the goods by the user and goods information from courier after a buyer has made a payment and signed for the goods, and sends the withholding instruction to the third-party payment platform. The transmission of the withholding instruction from the logistics company to the third-party payment platform can be done using any suitable communication tools, such as Internet and wireless communications.

At S224, after receiving the withholding instruction from the logistics company, the third-party payment platform verifies the withholding instruction based on the withholding agreement. The verification determines whether the logistics company which sends the withholding instruction and the logistics agency from which the withholding is made have signed an withholding agreement with the third-party payment platform, whether the withholding instruction satisfies the rules set in the withholding agreement, and whether identity information of the logistics company and the logistics agency from which the withholding is made are consistent with the information described in the withholding agreement.

At S226, upon successful verification, the third-party payment platform transfers a fund from the logistics agency's account to the logistics company's account.

After the payment has been transferred into the payment account of the logistics company, the logistics company may transfer the payment in the payment account into a bank account and then give the payment to the seller. Alternatively, the seller may register a payment account of its own on the third-party payment platform. The logistics company then transfers the payment into the seller's payment account on the third-party payment platform.

In one embodiment, transferring the fund from the account of the logistics agency to the account of the logistics company at the third-party payment platform to settle the payment is conducted immediately upon receiving and verifying the withholding instruction. This helps achieve and real-time fund settlement between the logistics company and the logistics agency upon a successful delivery of the goods. The disclosed method achieves real-time fund settlement between a logistics agency and a logistics company using a third-party payment platform to greatly increase the speed of fund transfer and fund settlement between the logistics agency and the logistics company. As such, a seller may receive a payment in its account in a shorter period of time. Furthermore, because a logistics agency is generally required to pay a security deposit to a logistics company during goods delivery, the method can shorten the period of the security deposit made by the logistics agency and therefore reduce financial pressure on the logistics agency.

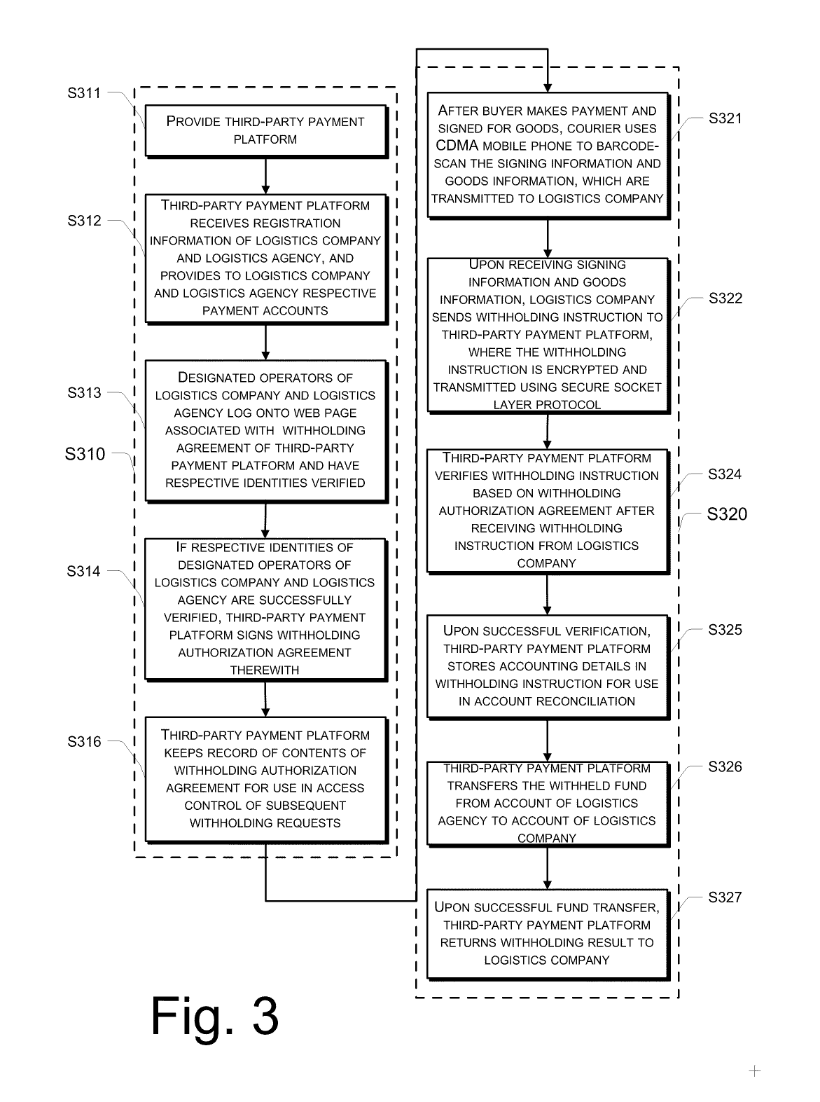

FIG. 3 shows a flow chart illustrating another exemplary method of settling a payment for a logistics company in real time. This method of settling a payment for a logistics company in real time includes a process of signing withholding agreement S310 and a process of real-time payment settlement S320. Signing a withholding agreement refers to a process of signing the withholding agreement by a logistics company, a logistics agency and a third-party payment platform. The process of signing withholding agreement S310 includes the following procedures.

At S311, a third-party payment platform is provided.

At S312, the third-party payment platform receives registration information of a logistics company and a logistics agency, and provides respective payment accounts to the logistics company and the logistics agency. During registration, the logistics company and the logistics agency may designate respective operators to log onto the third-party payment platform and input the registration information. The registration information may be a login account, a login password, a company name, etc. Upon successful registration, the third-party payment platform provides to the logistics company and the logistics agency their respective payment accounts.

At S313, the operators designated by the logistics company and the logistics agency log onto a web page of withholding agreement of the third-party payment platform and input respective passwords or digital certificates for identity verification. The passwords or the digital certificates to be entered by the operators may have been stored in the registration information in advance. The entered passwords or digital certificates are then examined against the previous stored passwords or digital certificates for consistency to verify identities of the operators.

At S314, if the operators designated by the logistics company and the logistics agency pass identity verification, the third-party payment platform signs a withholding agreement therewith. Contents of the withholding agreement include an agreement of the logistics company and the logistics agency to authorize the third-party payment platform to deduct funds from the accounts on the third-party payment platform according to a system command from the logistics company.

At S316, the third-party payment platform keeps a record of the contents of the withholding agreement for use in access control of subsequent withholding request. The contents of the withholding agreement include details of the authorization agreement and information of the three parties that have signed the agreement.

The process of real-time payment settlement S320 refers to a process of settling a fund transfer from the logistics agency's account to the logistics company's account in real time after a courier has received a payment from a buyer. The process includes the following procedures.

At S321, after a buyer has made a payment and signed for the goods, a courier uses a CDMA mobile phone to barcode-scan the signature information and goods information, and then transmits the information to the logistics company.

At S322, upon receiving the signature information and the goods information, the logistics company sends a withholding instruction to the third-party payment platform. The withholding instruction is encrypted and transmitted using secure socket layer protocol.

Secure Socket Layer is a secure communication protocol that is often used in World Wide Web. The Secure Socket Layer can ensure security of data information transmitted between a server and a browser. Using this protocol, networked data transmission performs different levels of encryption based on the type of a certificate (e.g., 30 bits or 128 bits) and examines integrity of the information.

At S324, after receiving the withholding instruction from the logistics company, the third-party payment platform verifies the withholding instruction based on the withholding agreement. The verification determines whether the logistics company which sends the withholding instruction and the logistics agency from which the withholding is made have signed an withholding agreement with the third-party payment platform, whether the withholding instruction satisfies the rules set in the withholding agreement, whether the fund to be deducted is within an allowable limit set in the agreement, and whether the identity information of the logistics company and the logistics agency from which the withholding is made are consistent with the information described in the withholding agreement, etc.

At S325, if verification is successful, the third-party payment platform stores the accounting details of the withholding instruction for use in account reconciliation. The accounting details to be stored include at least information of both parties associated with the withholding, the amount to be withheld (deducted), and date of withholding, etc.

At S326, the third-party payment platform transfers the withheld fund from the logistics agency's account to the logistics company's account.

At S327, upon successful fund transfer, the third-party payment platform returns a withholding result to the logistics company. If the fund transfer fails due to reasons such as insufficient funds in the logistics agency's account, the third-party payment platform may return an error message to the logistics company and the logistics agency. The logistics company may then perform collection accordingly.

In addition to using the third-party payment platform to achieve real-time fund settlement between a logistics company and a logistics agency, the disclosed method verifies a withholding instruction and the party from which the withholding instruction is sent, thus fully ensuring security of a fund transfer. Moreover, the present exemplary method stores the accounting details of the withholding instruction for use in account reconciliation between the logistics company and the logistics agency.

The present disclosure further provides a system of settling a payment for a logistics company in real time.

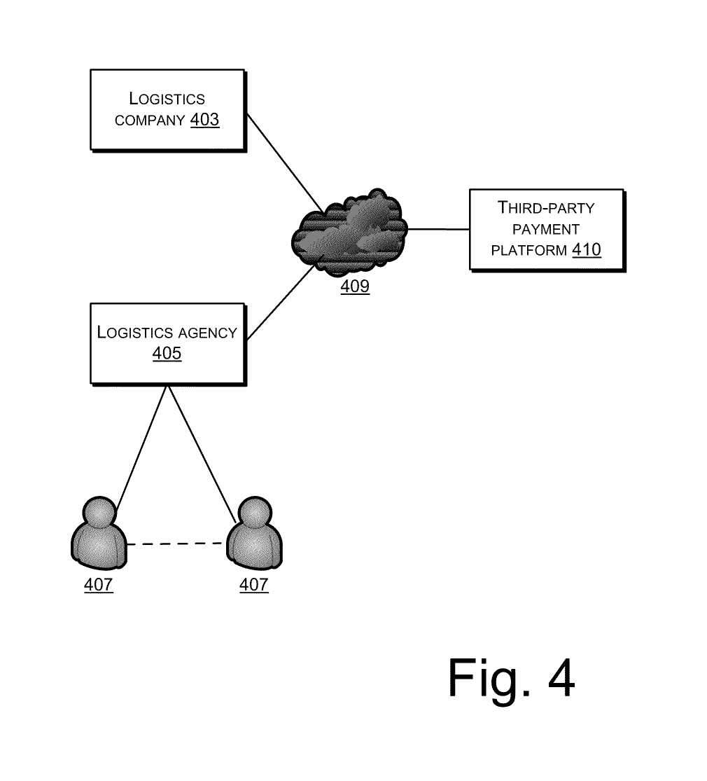

FIG. 4 shows an exemplary environment in which the system of settling a payment for a logistics company in real time is implemented. As shown in FIG. 4, the implementation environment involves a logistics company 403, a logistics agency 405 and a third-party payment platform 410. The logistics agency 405 and the logistics company 403 are connected to network 409. The third-party payment platform connects with the logistics company 403 and the logistics agency 405 through the network 409. The logistics agency 405 may be distributed in different geographical regions. Therefore, there may be one or more logistics agency 405. Each logistics agency 405 has a number of couriers 407 who are responsible for transportation and distribution of goods. After a buyer makes a payment and signs for the goods, the courier 407 sends signature information and goods information to the logistics company 403. Upon receiving the signature information and the goods information from the courier 407, the logistics company 403 sends a withholding instruction to the third-party payment platform 410 and transfers in real time the payment from an account of the logistics agency 405 into an account of the logistics company 403 through the third-party payment platform 410. Therefore, the speed of fund transfer between the logistics company 403 and the logistics agency 405 is increased.

The third-party payment platform 410 is the core of the disclosed system of payment settlement, as described in details below.

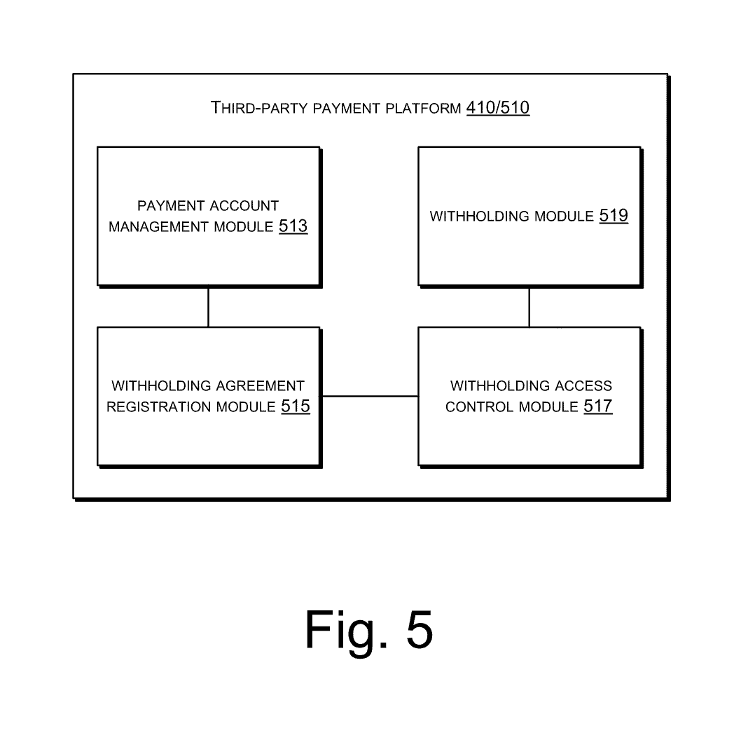

FIG. 5 shows a structural diagram illustrating an exemplary third-party payment platform in accordance with the present disclosure. The third-party payment platform 410/510 includes a third-party payment account management module 513, a third-party payment platform withholding agreement registration module 515, a third-party payment platform withholding access control module 517 and a third-party payment platform withholding module 519. The payment account management module 513 and the withholding agreement registration module 515 connect with the logistics company 403 and the logistics agency 405 through the network 409. The withholding access control module 517 connects with the withholding agreement registration module 515. The withholding module 519 connects with the withholding access control module 517.

In the presence disclosure, a “module” or a “unit” in general refers to a functionality designed to perform a particular task or function. A module or a unit can be a piece of hardware, software, a plan or scheme, or a combination thereof, for effectuating a purpose associated with the particular task or function. In addition, delineation of separate units does not necessarily suggest that physically separate devices are used. Instead, the delineation may be only functional, not structural, and the functions of several units may be performed by a single combined device or component. When used in a computer-based system, regular computer components such as a processor, a storage and memory may be programmed to function as one or more units or devices to perform the various respective functions.

The third-party payment platform 510 may be a server computer system having one or more servers. In one embodiment, one or more of the above modules is a separate server computer programmed or adapted for performing the respective function.

Prior to conducting payment withholding on the third-party payment platform 410/510, the logistics company 403 and the logistics agency 405 are required to register and apply for a respective payment account on the third-party payment platform first. Upon successful registration, the logistics company 403 and the logistics agency 405 need to log into the payment account management module 513 and sign a withholding agreement to authorize the third-party payment platform 510 to withhold (deduct) funds from their accounts on the third-party payment platform 510 according to a withholding system command from the logistics company 403. Specifically, the logistics company 403, the logistics agency 405 and the third-party payment platform 410/510 need to conclude a three-party withholding agreement.

After the three-party withholding agreement is signed, upon receiving a withholding instruction from the logistics company 403, the third-party payment platform 510 verifies the authenticity of the withholding instruction through the withholding access control module 517. The verification determines whether the logistics company 403 which sends the withholding instruction and the logistics agency 405 from which the withholding is made have signed an withholding agreement with the third-party payment platform 510, whether the withholding instruction satisfies the rules set in the withholding agreement, and whether the identity information of the logistics company 403 and the logistics agency 405 from which the withholding is made is consistent with the information provided in the withholding agreement, etc. Upon successful verification, the withholding module 519 transfers a fund from the account of the logistics agency 405 to the account of the logistics company 403.

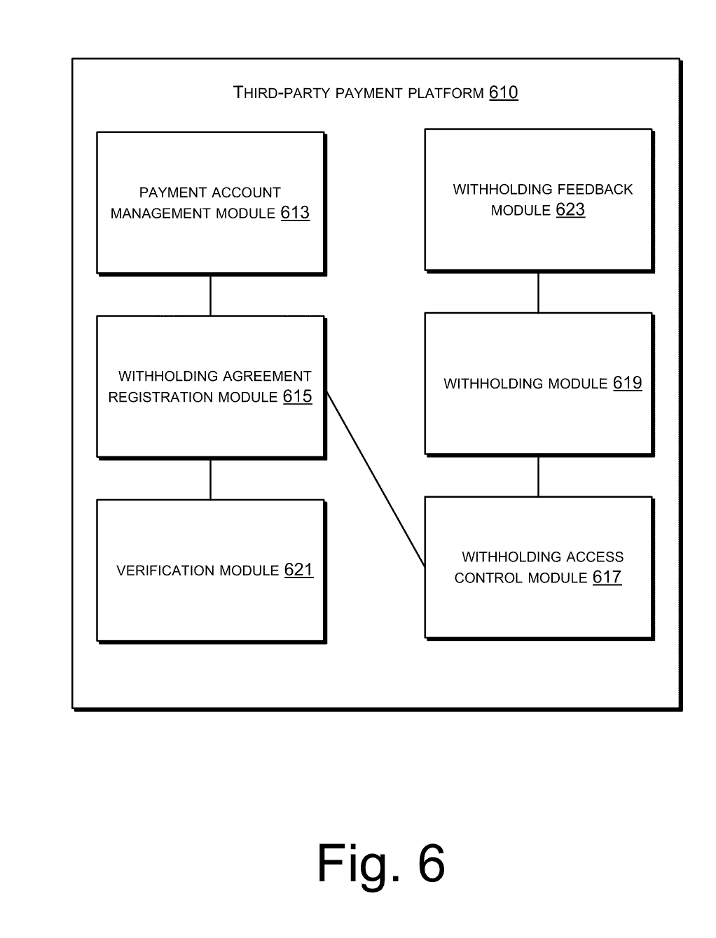

FIG. 6 shows a structural diagram illustrating another exemplary third-party payment platform in accordance with the present disclosure. The third-party payment platform 510 includes a payment account management module 613, a withholding agreement registration module 615, a withholding access control module 617, a withholding module 619, a verification module 621, and a withholding feedback module 623. The account management module 613 and the withholding agreement registration module 615 connect with the logistics company 403 and the logistics agency 405 through the network 409. The withholding access control module 617 connects with the withholding agreement registration module 615. The withholding module 619 connects to the withholding access control module 617. The verification module 621 connects to the withholding agreement registration module 615. The withholding feedback module 623 connects with the withholding module 619.

The third-party payment platform 610 of FIG. 6 adds verification module 621 and withholding feedback module 623 to the third-party payment platform 510 shown in FIG. 5. The verification module 621 is used for verifying identities of the logistics company 403 and the logistics agency 405 when the withholding agreement registration module 615 signs the withholding agreement with the logistics company 403 and the logistics agency 405. Specifically, the withholding agreement registration module 615 first checks whether the logistics company 403 and the logistics agency signing the agreement have already registered accounts on the third-party payment platform. This may be performed by way of entering a password or a digital certificate. The withholding feedback module 623 is used for returning a withholding result to the logistics company after the fund transfer between the logistics company 403 and the logistics agency 405 is successful. If the fund transfer fails due to reasons such as insufficient funds in the payment account of the logistics agency 405, the withholding feedback module 623 may send an error message to the logistics company 403 and the logistics agency 405. The logistics company 403 may then perform collection accordingly.

Compared with existing technologies, the present disclosure has the following advantages.

1. The disclosed method and system achieve real-time fund settlement between a logistics agency and a logistics company using a third-party payment platform, and increases the speed of fund transfer and fund settlement between the logistics agency and the logistics company. Therefore, the time taken for a seller to receive a payment is shortened with improved efficiency of the logistics company. This may give the logistics company using the method and system a competitive edge to other companies of the same business.

2. The disclosed method and system using a third-party payment platform also lead to a shorter time duration of a security deposit made by the logistics agency to the logistics company. This decreases the financial pressure on the logistics agency as well as the operating difficulties.

3. The disclosed method and system can be adapted to verify a withholding request and a party from which the withholding request is sent. Moreover, based on the secure socket layer protocol, the withholding instruction between a logistics company and a third-party payment platform can be encrypted before transmission to ensure the security of a payment transfer between the logistics company and the logistics agency.

4. The third-party payment platform in the disclosed method and system may further provide to a logistics company and a logistics agency the accounting details in the fund withholding process convenient account checking.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method of settling a payment between a logistics company and a logistics agency delivering goods on behalf of the logistics company, the method comprising:
providing a third-party payment platform;
signing a withholding agreement among the logistics company, the logistics agency and the third-party payment platform;
establishing an account for the logistics company and an account for the logistics agency at the third-party payment platform;
receiving at the third-party payment platform a withholding instruction from the logistics company which sends the withholding instruction upon receiving delivery information from a courier of the logistics agency indicating that a buyer has made a payment and signed for receipt of the goods;
verifying the withholding instruction based on the withholding agreement; and
transferring a fund from the account of the logistics agency to the account of the logistics company at the third-party payment platform to settle the payment.

2. The method as recited in claim 1, wherein transferring the fund from the account of the logistics agency to the account of the logistics company at the third-party payment platform to settle the payment is conducted immediately upon receiving and verifying the withholding instruction to achieve real-time fund settlement between the logistics company and the logistics agency upon a successful delivery of the goods.

3. The method as recited in claim 1, further comprising:
saving a record of the withholding agreement and the third-party payment platform for use in access control of subsequent withholding requests.

4. The method as recited in claim 1, further comprising:
verifying identities of the logistics company and the logistics agency when signing the withholding agreement.

5. The method as recited in claim 4, wherein verifying the identities of the logistics company and the logistics agency comprising checking a respective password and/or a digital certificate.

6. The method as recited in claim 1, wherein the delivery information received by the logistics company is obtained by the courier using a CDMA mobile phone to barcode-scan signature information of the buyer and product information of the goods delivered.

7. The method as recited in claim 1, wherein the withholding instruction is encrypted and transmitted using a secure socket layer protocol by the logistics company to the third-party payment platform.

8. The method as recited in claim 1, further comprising:
saving at the third-party payment platform accounting details in the received withholding instruction for use in account reconciliation.

9. The method as recited in claim 1, further comprising:
returning a withholding result to the logistics company after transferring the fund.

10. A system of settling a payment between a logistics company and a logistics agency delivering goods on behalf of the logistics company, the system comprising one or more server computers programmed or adapted for acting as a third-party payment platform which signs a withholding agreement with the logistics company and the logistics agency, wherein the third-party payment platform is further adapted for performing the following acts:
establishing an account for the logistics company and an account for the logistics agency at the third-party payment platform;
receiving a withholding instruction from the logistics company which sends the withholding instruction upon receiving delivery information from a courier of the logistics agency indicating that a buyer has made a payment and signed for receipt of the goods;
verifying the withholding instruction based on the withholding agreement; and
transferring a fund from the account of the logistics agency to the account of the logistics company at the third-party payment platform to settle the payment.

11. The system as recited in claim 10, wherein transferring the fund from the account of the logistics agency to the account of the logistics company at the third-party payment platform to settle the payment is conducted immediately upon receiving and verifying the withholding instruction to achieve real-time fund settlement between the logistics company and the logistics agency upon a successful delivery of the goods.

12. The system as recited in claim 10, wherein the third-party payment platform is connected to the logistics agency and the logistics company through a network.

13. The system as recited in claim 10, wherein the third-party payment platform comprises:
a payment account management module adapted for establishing the account for the logistics company and the account for the logistics agency;
a withholding agreement registration module connecting with the logistics company and the logistics agency, the withholding agreement registration module being adapted for signing the withholding agreement among the logistics company, the logistics agency and the third-party payment platform;
a withholding access control module connecting with the withholding agreement registration module, the withholding access control module being adapted for keeping a record of the withholding agreement for use in access control of subsequent withholding requests; and
a withholding module separately connecting with the withholding access control module and the payment account management module, the withholding module being adapted for transferring the fund from the account of the logistics agency to the account of the logistics company upon receiving the withholding instruction.

14. The system as recited in claim 13, wherein at least one of the modules comprises a separate server computer.

15. The system as recited in claim 10, wherein the third-party payment platform further comprises:
a verification module connecting with the withholding agreement registration module, the verification module being adapted for verifying identities of the logistics company and the logistics agency when the withholding agreement module signs the withholding agreement with the logistics company and the logistics agency.
